(19) United States
(12) Patent Application Publication
(10) Pub. No.: US 2008/0028309 A1
(43) Pub. Date: Jan. 31, 2008

(54) INPUT DEVICE

(75) Inventors: Hiroshi Wakuda, Niigata-ken (JP); Tetsuya Mitsuishi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/774,924

(22) Filed: Jul. 9, 2007

(30) Foreign Application Priority Data
Jul. 28, 2006 (JP) 2006-205956

(51) Int. Cl. G06F 3/01

(52) U.S. Cl. 715/702

(57) ABSTRACT

An input device performs various input operations in a secure manner on the same operation plane. A sheet-like display member formed of an organic electroluminescence selectively displays a keyboard input display pattern, a specific operation plane display pattern, and a pad input section display pattern. Additionally, a partial pressing member is configured to press operation areas of the display patterns from downside so that the operations areas are partially deformed in a protruding manner. As a result, the protruding operation areas are clearly sensed by means of sight and touch. Furthermore, a contact position of a finger is detected by an electrostatic capacitance type sheet-like detection member laminated on the sheet-like display member.

This application claims the benefit of Japanese Patent Application No. 2006-205956 filed Jul. 28, 2006, the entire contents of which are incorporated herein by reference.

### BACKGROUND OF THE INVENTION

1. Technical Field

The present invention relates to an input device capable of selectively displaying various operation instruction patterns on a common operation plane and thus enabling various input methods.

2. Description of the Related Art

In various electronic devices such as computers and portable communication devices, a key input section having a plurality of keys arranged thereon, a rotation input section, a coordinate input section such as an electrostatic capacitance type input pad are provided on a operation plane.

Since the key input section, the rotation input section, and the coordinate input section are independently operated when users perform various input operations, in order to realize various input operations, the entire input sections should be arranged separately from each other on the operation plane. Thus, there is a limit in decreasing the size of the operation plane.

Additionally, an input device may be conceivable in which an input operation similar to a key input and a coordinate input operation are performed using the electrostatic capacitance type input pad. However, such an input device cannot display various display patterns on the surface of the input pad, and thus it is difficult to perform various input operations in a secure manner without mistakes.

Further, in JP-A-2000-148393 and JP-A-2005-055489, there is disclosed an input device in which a partial area of the operation plane is configured to protrude to allow users to sense an operation area by means of touch. Even in such an input device, it is difficult to perform various input operations while allowing users to sense individual operation areas by means of touch and sight.

### SUMMARY OF THE INVENTION

The invention solves the aforementioned problems, and its object is to provide an input device capable of displaying various input sections on a common operation plane with a limited area while allowing users to sense the various input sections by means of touch and sight.

According to a first aspect of the invention, there is disclosed an input device including a sheet-like detection member configured to be deformable and detect a contact position of operation means, a sheet-like display member laminated on the sheet-like detection member and configured to be deformable and selectively display various operation instruction patterns, and a partial pressing member configured to press partial areas of the sheet-like detection member and the sheet-like display member from downside so that the members are partially deformed in a protruding manner, in which when one of the operation instruction patterns is displayed on the sheet-like display member, the partial pressing member presses a corresponding operation area of the operation instruction pattern displayed on the sheet-like display member, and areas of the sheet-like detection member and the sheet-like display member corresponding to the operation area are deformed in a protruding manner, thereby allowing the sheet-like detection member to detect the contact position of the operation means with the operation area.

Since the input device has a configuration in which the various operation instruction patterns are selectively displayed by the sheet-like display member and a corresponding operation area of the operation instruction pattern is partially deformed in a protruding manner by the partial pressing member, users can sense the operation instruction pattern selectively displayed on the same operation plane by means of sight and touch. Moreover, when fingers operate the protruding operation area, the sheet-like detection member detects a contact position of the operation means with the operation area.

In the above aspect of the invention, the operation instruction pattern includes a keyboard input display pattern having a plurality of key input operation areas and a coordinate input region display pattern indicating a constant coordinate input region.

Since the input device has a configuration in which the operation instruction pattern displays a keyboard operation area and a coordinate input area, a keyboard input operation and a coordinate input operation can be performed on the same operation plane.

In the above aspect of the invention, the sheet-like display member includes a display layer and upper and lower electrodes disposed respectively in the upper and lower layers of the display layer, and the upper electrode has a shape corresponding to the various operation instruction patterns, and the display layer is formed of an organic electroluminescence layer.

Since the electrodes corresponding to the operation instruction patterns are preformed on the sheet-like display member, selectively displaying the operation instruction pattern is easily performed on the sheet-like display member.

In the above aspect of the invention, the sheet-like detection member detects the contact position of the operation means on the basis of a variation in electrostatic capacity between electrodes.

In the above aspect of the invention, the partial pressing member allows a plurality of small protrusions to press the same operation area.

According to the above-mentioned configurations, the operation area of the operation instruction pattern is displayed to be sensed by sight and deformed in a protruding manner to be sensed by touch at the time of selectively displaying the operation instruction pattern. Therefore, the various operation instruction patterns can be securely performed with a limited area.

Other systems, methods, features, and advantages of the invention will be, or will become, apparent to one with skill in the art upon examination of the following figures and detailed description. It is intended that all such additional systems, methods, features, and advantages be included within this description.

### BRIEF DESCRIPTION OF THE DRAWINGS

The components in the figures are not necessarily to scale, emphasis instead being placed upon illustrating the principles of the invention. Moreover, in the figures, like referenced numerals designate corresponding parts throughout the different views.

FIG. 1 is an exploded perspective view of an input device in accordance with embodiments.

FIG. 2 is a top plan view of a sheet-like display member.

FIG. 3 is a sectional view of the input device in a non-operating state.

FIG. 4 is a sectional view of the input device in an operating state.

FIG. 5 is a perspective view of the input device operating in a keyboard input mode.

FIG. 6 is a perspective view of the input device operating in a specific region input mode.

FIG. 7 is a perspective view of the input device operating in a pad input mode.

### DESCRIPTION OF THE PREFERRED EMBODIMENTS

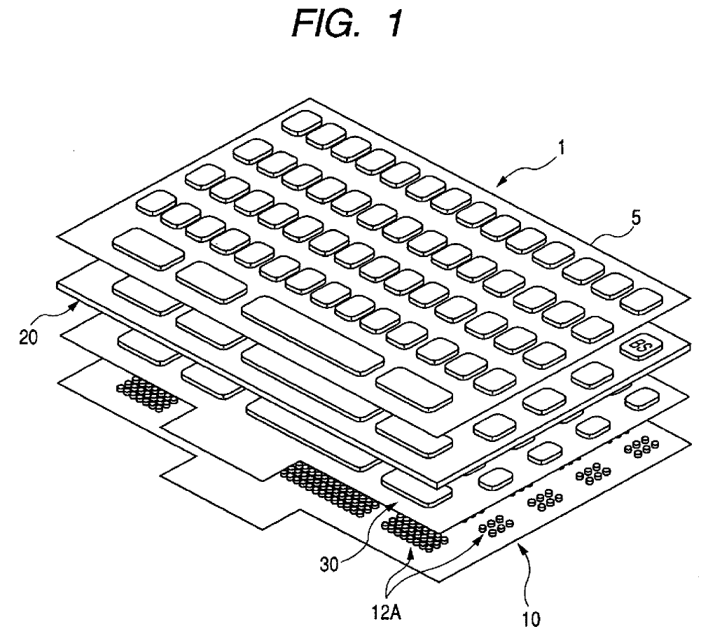

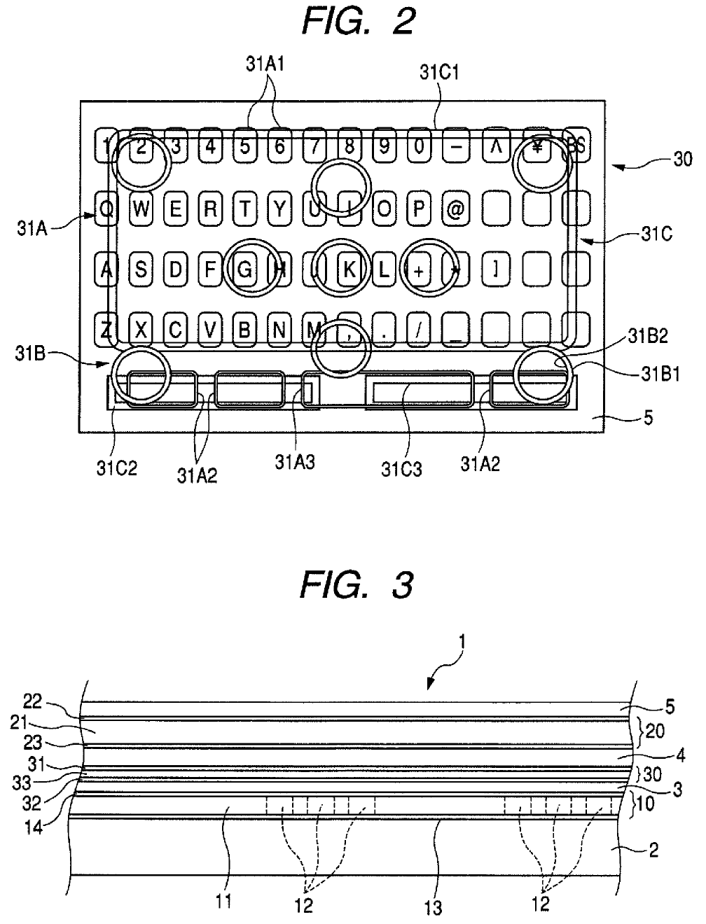

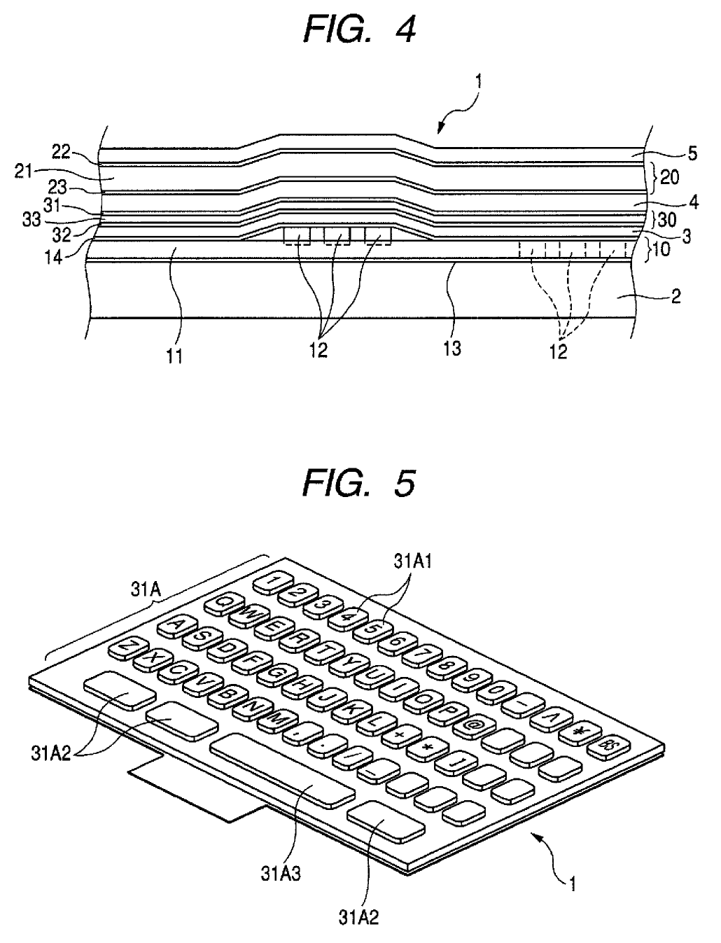

FIG. 1 is an exploded perspective view of an input device in accordance with an embodiment of the invention, which shows the state where sheet-like members are partially deformed in a protruding manner by a partial pressing operation of a partial pressing member. FIG. 2 is a top plan view of a sheet-like display member. FIG. 3 is a partially sectional view of the input device in which a partial pressing member is in a non-operating state, and FIG. 4 is a partially sectional view of the input device in which the partial pressing member is in an operating state and the sheet-like detection member and the sheet-like display member are partially deformed in a protruding manner. FIGS. 5, 6, and 7 are perspective views of operation instruction patterns displayed on the sheet-like display member.

As shown in FIGS. 3 and 4, an input device 1 includes a rigid substrate 2 in the lowest layer. The partial pressing member 10 is laminated on the substrate 2 and fixed thereto. A lower-side middle substrate 3 is laminated on the partial pressing member 10 and a sheet-like display member 30 is laminated on the lower-side middle substrate 3. An upper-side middle substrate 4 is laminated on the sheet-like display member 30 and a sheet-like detection member 20 is laminated on the upper-side middle substrate 4. Additionally, a surface sheet 5 covers the sheet-like detection member 20.

The partial pressing member 10, the sheet-like display member 30, the sheet-like detection member 20, and the surface sheet 5 of the configuration components are shown in FIG. 1. All of the partial pressing member 10, the lower-side middle substrate 3, the sheet-like display member 30, the upper-side middle substrate 4, the sheet-like detection member 20, and the surface sheet 5 have the same shape and size. Further, the lower-side middle substrate 3, the sheet-like display member 30, the upper-side middle substrate 4, the sheet-like detection member 20, and the surface sheet 5 are deformable. As shown in FIG. 3, every sheet and substrate is of a plane shape unless an outer force acts thereon. As shown in FIGS. 1 and 4, when the every substrate is partially pressed in an upward direction by the partial pressing member 10, the lower-side middle substrate 3, the sheet-like display member 30, the upper-side middle substrate 4, the sheet-like detection member 20, and the surface sheet 5 in a pressed part are partially deformed in a protruding manner.

The upper-side middle substrate 4 and the surface sheet 5 are formed of a flexible and transparent elastomer sheet. Additionally, the lower-side middle substrate 3 is also formed of the elastomer sheet.

The sheet-like display member 30 is configured to selectively display a plurality of operation instruction patterns. As shown in FIG. 3, the sheet-like display member 30 includes upper electrodes 31 formed on a lower surface of the upper-side middle substrate 4 and lower electrodes 32 formed on an upper surface of the lower-side middle substrate 3. Additionally, a display layer 33 is interposed between the upper electrodes 31 and the lower electrodes 32. The display layer 33 is of an organic electroluminescence layer.

The lower electrodes 32 constituting the sheet-like display member 30 are formed on an entire display region with a predetermined film thickness. The upper electrodes 31 have a shape corresponding to that of every operation area of the plurality of operation instruction patterns.

FIG. 2 is a top plan view of a pattern of the upper electrodes 31 of the sheet-like display member 30. One of the operation instruction patterns displayed by the upper electrodes 31 is a keyboard input display pattern 31A. FIG. 5 shows a state where the sheet-like display member 30 represents a keyboard input display section 31A. The keyboard input display pattern 31A includes a plurality of small-sized key display portions 31A1 regularly arranged in lengthwise and breadthwise, three middle-sized key display portions 31A2 closely disposed on a user's side rather than the small-sized key display portions 31A1 and disposed in a width direction with a predetermined gap, and one long-sized display portion 31A3 disposed between three middle-sized key display portions 31A2.

In the small-sized key portions 31A1, parts of the upper electrodes 31 are deformed so as to represent shapes of outlines of the small-sized keys and numbers or signs displayed on the small-sized key. Additionally, in the middle-sized key portions 31A2 and the long-sized key portion 31A3, parts of the upper electrodes 31 are deformed so as to represent outlines of shapes of the long-sized keys in the width direction. However, in the small-sized key portions 31A1, the upper electrodes 31 may be densely formed inside the outlines of the small-sized key portions so as to fill the inside of the outlines of the small-sized key portions, and the upper electrodes 31 may lack in parts of the numbers of signs. Further, in the middle-sized key portions 31A2 and the long-sized key portion 31A3, the upper electrodes 31 may be formed inside the outlines of the long-sized key portions.

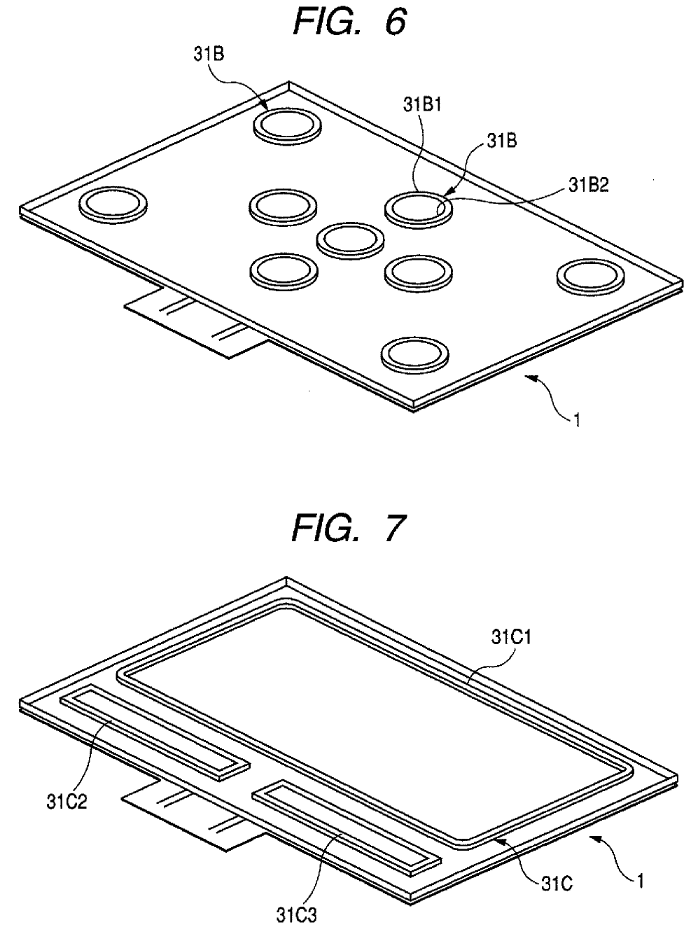

Specific operation plane display patterns 31B are formed by parts of the upper electrodes 31 of the sheet-like display member 30. FIG. 6 shows a state where only the specific operation plane display patterns 31B are displayed on the sheet-like display member 30. Nine of the specific operation plane display patterns 31B are provided in the display region. The specific operation plane display patterns 31B have an outer circle 31B1 and an inner circle 31B2 disposed inside the outer circle 31B1 with a predetermined gap, respectively. The outer circles 31B1 and the inner circles 31B2 are formed into a concentric circle by parts of the upper electrodes 31 with those concentric circles apart from one another. However, gaps between the outer circles 31B1 and the inner circles 31B2 may be filled with the upper electrodes 31.

Moreover, a pad input section display pattern 31C is formed on the sheet-like display member 30 by parts of the upper electrodes 31. FIG. 7 shows a state where only the pad input section display pattern 31C is displayed by the sheet-like display member 30. The pad input section display pattern 31C includes a coordinate input region display pattern 31C1 indicating a constant coordinate input region by the use of parts of the upper electrodes 31. The coordinate input region display pattern 31C1 has a shape of a frame enclosing the coordinate input region and the frame is formed by the upper electrodes 31.

An L-key input region display pattern 31C2 and an R-key input region display pattern 31C3 are closely formed on the user's side rather than the coordinate input region display pattern 31C1 in the pad input section display pattern 31C. Thin and long frames enclosing key input regions are formed in the L-key input region display pattern 31C2 and the R-key input region display pattern 31C3 by the use of the upper electrodes 31.

As shown in FIG. 2, the upper electrodes 31 are formed on the basis of shapes of the keyboard input display pattern 31A, the specific operation plane display pattern 31B, and the pad input section display pattern 31C, but the respective upper electrodes 31 for displaying the respective patterns 31A, 31B, and 31C are independently formed with a minute gap so as not to be in a short state. For example, as shown in FIG. 2, outlines, characters, and number of the small-sized key portions 31A1 and the double-circle specific operation plane display patterns 31B are formed with a minute gap.

The display layer 33 of the sheet-like display member 30 is of the organic electroluminescence layer and selectively electrically connects the upper electrodes of the patterns 31A, 31B, and 31C on the basis of a control operation of a control unit (not shown), thereby selectively displaying the keyboard input display pattern 31A shown in FIG. 5, the specific operation plane display pattern 31B shown in FIG. 6, and the pad input section display pattern 31C shown in FIG. 7.

The display layer 33 is formed of the single organic electroluminescence layer, and thus displays the display patterns 31A, 31B, and 31C shown in FIGS. 5, 6, and 7 as the same color. However, when corresponding parts of the upper electrodes 31 of the display patterns 31A, 31B, and 31C are dividedly formed of different organic electroluminescence layers by the use of a print method, the display patterns 31A, 31B, and 31C shown in FIGS. 5, 6, and 7 may be displayed as different colors.

The sheet-like detection member 20 is laminated on the sheet-like display member 30. The sheet-like detection member 20 has the flexible and transparent supporting sheet 21. Upper electrodes 22 are formed on a front surface of the supporting sheet 21 and lower electrodes 23 are formed on a rear surface of the supporting sheet 21. The upper electrodes 22 and the lower electrodes 23 are transparent electrodes such as ITO, respectively.

The upper electrodes 22 have a structure in which a plurality of linear electrodes are parallel formed with a uniform gap. The lower electrodes 23 have a structure in which a plurality of linear electrodes are also parallel formed with a uniform gap. The upper electrodes 22 and the lower electrodes 23 are disposed to be at right angle with each other. Additionally, detection electrodes are parallel formed between the adjacent upper electrodes 22 or between the adjacent lower electrodes 23. When the control unit (not shown) controls a driving circuit, the driving circuit sequentially applies voltage to the upper electrodes 22 and applies voltage to the lower electrodes 23 at a different time from that of the upper electrodes 22.

When a finger acting as an electric conductor touches a certain position of the surface sheet 5, electrostatic capacity varies between the upper electrodes 22 or the lower electrodes 23 adjacent to the finger contacting position and the detection electrodes adjacent thereto. Accordingly, when voltage is applied to the upper electrodes 22 and the lower electrodes 23, rising time of voltage is varied by a difference of electrostatic capacity. A distribution of electrostatic capacity can be sensed by detecting a variation of the rising time, and thus a position that the finger touches can be specified as a position in X-Y coordinate.

Further, the sheet-like detection member 20 may be configured as any structure in which the position that the finger touches can be specified as the position in X-Y coordinate when the finger touches the surface sheet 5 or the finger presses the surface sheet 5. For example, the sheet-like detection member 20 may be configured as one in which plane-shape resistors are disposed to be opposed to each other with a minute gap and positions that resistances contact with each other can be specified on the basis of voltage drop, and one in which X and Y electrodes cross to each other, oppose to each other with a minute gap, and a position of contacting the X and Y electrodes can be specified.

The partial pressing member 10 disposed on a lower side of the sheet-like display member 30 has a relatively rigid substrate 11, and a plurality of small protrusions 12 are formed on the substrate 11. Protrusion actuators of a shape memory alloy or a piezoelectric element are formed below the small protrusions 12. Lower electrodes 13 commonly electrically connecting the protrusion actuators are formed below the small protrusions 12 and the protrusion actuators. Additionally, upper electrodes 14 individually electrically connecting the small protrusions 12 or groups 12A of the small protrusions 12 are formed above the small protrusions 12 and the protrusion actuators.

As shown in FIG. 1, the small protrusions 12 constitutes the groups 12A, and the respective groups 12A have shapes corresponding to the operation areas of the keyboard input display pattern 31A, the specific operation plane display pattern 31B, and the pad input section display pattern 31C respectively formed of the upper electrodes 31.

Next, an operation of the input device 1 will be described. FIG. 3 shows a state where voltage is not applied between the lower electrodes 13 and the upper electrodes 14 of the partial pressing member 10, and the small protrusions 12 of all groups 12A regress. As a result, every layer from the lower-side middle substrate 3 to the surface sheet 5 is flat and the surface of the surface sheet 5 is flat as well. Further, when voltage is not applied between the upper electrodes 31 and the lower electrodes 32 of the sheet-like display member 30 as in the state of FIG. 3, the sheet-like display member 30 does not display any pattern.

When an operation unit (not shown) is operated in the state shown in FIG. 3, the input device 1 is changed to one of a keyboard input mode shown in FIG. 5, a specific operation input mode shown in FIG. 6, and a pad input mode shown in FIG. 7.

Alternatively, when a power is applied to the device, as shown in FIG. 3, in the state where the partial pressing member 10 is not operated and every sheet and layer is flat, only the sheet-like display member 30 and the sheet-like detection member 20 may be operated. In this case, for example, the keyboard input display pattern 31A shown in FIG. 5 or the specific operation plane display pattern 31B shown in FIG. 6 is displayed on the sheet-like display member 30. When the finger touches a predetermined operation area of the display pattern as described above, the sheet-like detection member 20 detects the finger contacting position, and thus any one of the modes shown in FIGS. 5, 6, and 7 may be performed.

When the keyboard input mode shown in FIG. 5 is set by the operation, voltage is applied between the lower electrodes 32 of the sheet-like display member 30 and the electrodes that form the keyboard input display pattern 31A among the upper electrodes 31 by the control operation of the control unit. As a result, the display layer 33 formed of the organic electroluminescence brightly displays the outlines, the numbers, and the signs of the small-sized key portions 31A1 and the outlines of the middle-sized key portions 31A2 and the long-sized key portion 31A3.

When the upper electrodes of the sheet-like display member 30 are selected, at the same time the upper electrodes 14 of the partial pressing member 10 are selected, and thus the control unit applies voltage between the selected upper electrodes 14 and the lower electrodes 13. At this time, as shown in FIG. 1 voltage is applied to the groups 12A of the small protrusions 12 disposed below the small-sized key portions 31A1, the middle-sized key portions 31A2, and the long-sized key portion 31A3 of the keyboard input display pattern 31A. When the small protrusions 12 constituting the groups 12A protrude, as shown in FIG. 4, every sheet and layer from the lower-side middle substrate 3 to the surface sheet 5 is partially pressed and deformed in a protruding manner by the plurality of small protrusions constituting the groups 12A.

As a result, as shown in FIG. 5 the keyboard input display pattern 31A is brightly displayed and the small-sized key portions 31A1, the middle-sized key portions 31A2, and the long-sized key portion 31A3 protrude more than other parts. At this time, a protrusion height is in the range of about 0.1 to 0.5 mm or so, and when a person's finger touches the surface of the surface sheet 5, the finger can sense the small-sized key portions 31A1, the middle-sized key portions 31A2, and the long-sized key portion 31A3 by the means of touch.

As in the state where the keyboard input mode shown in FIG. 5 is set, when the finger touches the surface of the surface sheet 5, the finger contacting position on the surface of the surface sheet 5 can be detected by the use of a detection operation of the sheet-like detection member 20. At this time, the control unit ignores position information among coordinate detection signals acquired from the sheet-like detection member 20 other than those acquired from the surface of the small-sized key portions 31A1, the middle-sized key portions 31A2, and the long-sized key portion 31A3. With such a configuration, it is possible to sense the position where the finger touches the small-sized key portions 31A1, the middle-sized key portions 31A2, and the long-sized key portion 31A3 by the use of the coordinate detection signals acquired from the sheet-like detection member 20, thereby allowing the control unit to produce a keyboard input signal.

With such an operation, when the specific operation mode is set, as shown in FIG. 6, the sheet-like display member 30 displays the specific operation plane display pattern 31B. In the specific operation plane display pattern 31B, a plurality of outer circles 31B1 and inner circles 31B2 are displayed. Additionally, the upper electrodes 14 of the partial pressing member 10 are selected, and the control unit applies voltage between the selected upper electrodes 14 and the lower electrodes 13. As a result, the groups 12A of the small protrusions 12 with a ring shape disposed below ring-shape regions between the outer circles 31B1 and the inner circles 31B2 of the specific operation plane display pattern 31B protrude, and, as shown in FIG. 6, in the regions between the outer circles 31B1 and the inner circles 31B2, every sheet and layer from the lower-side middle substrate 3 to the surface sheet 5 is partially pressed and deformed in a protruding manner. Alternatively, entire concentric circle regions enclosed by the outer circle 31B1 may be deformed in a protruding manner.

When the specific operation mode is set as shown in FIG. 6, the sheet-like detection member 20 detects only the coordinate detection of the plurality of specific operation plane display patterns 31B uplifted from the surface of the surface sheet 5, and the control unit ignores coordinate detection signals other than the specific operation plane display patterns 31B.

When the detection operation of the sheet-like detection member 20 detects the position where the finger touches one of the specific operation plane display patterns 31B, a different input operation is performed on the basis of the position where the finger touches one of the specific operation plane display patterns 31B. At this time, operations of the plurality of the specific operation plane display patterns 31B perform control operations of game software and the like. When the finger touches one of the plurality of specific operation display patterns 31B, an operation of scrolling content displayed on a screen or an operation of moving steps of characters displayed on the screen is performed.

In addition, when the finger touches a region between the outer circle 31B1 and the inner circle 31B2 of one of the specific operation plane display patterns 31B and slides on the region between the outer circle 31B1 and the inner circle 31B2, the sheet-like detection member 20 detects the rotation movement, and thus an operation of rotating the character displayed on the screen can be performed.

When the pad input mode is set as shown in FIG. 7, the coordinate input region display pattern 31C1, the L-key input region display pattern 31C2 and the R-key input region display pattern 31C3 of the pad input section display pattern 31C are displayed. Further, voltage is applied to the partial pressing member 10, and in the frame region of the coordinate input region display pattern 31C1, every sheet and layer from the lower-side middle substrate 3 to the surface sheet 5 is partially pressed and deformed in a protruding manner. Additionally, the L-key input region display pattern 31C2 and the R-key input region display pattern 31C3 are deformed in a protruding manner.

In the pad input mode shown in FIG. 7, when the finger touches a region inside the frame region of the coordinate input region display pattern 31C1, the sheet-like detection member 20 performs a coordinate detection of the position where the finger touches. With such an operation, it is possible to draw a character or a picture with the finger so as to input them into the control unit and display them on the screen. Additionally, when the sheet-like detection member 20 detects the position where the finger touches the L-key input region display pattern 31C2 or the R-key input region display pattern 31C3, the control unit may generate the same operation signal that a mouse button is pressed.

The invention is not limited to the embodiment, but may be configured such that the operation instruction pattern of the sheet-like display member 30 is a number keypad display, an arrow key display, or the like. Moreover, a display type of the sheet-like display member may be an LCD or the like.

What is claimed is:

1. An input device comprising:
a sheet-like detection member configured to be deformable and detect a contact position of operation means;
a sheet-like display member laminated on the sheet-like detection member and configured to be deformable and selectively display various operation instruction patterns; and
a partial pressing member configured to press partial areas of the sheet-like detection member and the sheet-like display member from downside so that the members are partially deformed in a protruding manner,
wherein when one of the operation instruction patterns is displayed on the sheet-like display member, the partial pressing member presses a corresponding operation area of the operation instruction pattern displayed on the sheet-like display member, and areas of the sheet-like detection member and the sheet-like display member corresponding to the operation area are deformed in a protruding manner, thereby allowing the sheet-like detection member to detect the contact position of the operation means with the operation area.

2. The input device according to claim 1, wherein the operation instruction pattern includes a keyboard input display pattern that has a plurality of key input operation areas and a coordinate input region display pattern that indicates a constant coordinate input region.

3. The input device according to claim 1, wherein the sheet-like display member includes a display layer and upper and lower electrodes disposed respectively in the upper and lower layers of the display layer, and the upper electrode has a shape corresponding to the various operation instruction patterns.

4. The input device according to claim 3, wherein the display layer is formed of an organic electroluminescence layer.

5. The input device according to claim 1, wherein the sheet-like detection member detects the contact position of the operation means on the basis of a variation in electrostatic capacity between electrodes.

6. The input device according to claim 1, wherein the partial pressing member allows a plurality of small protrusions to press the same operation area.

7. An electronic device comprising:
an input device, the input device comprising a sheet-like detection member configured to be deformable and detect a contact position of operation means, a sheet-like display member laminated on the sheet-like detection member and configured to be deformable and selectively display various operation instruction patterns, and a partial pressing member configured to press partial areas of the sheet-like detection member and the sheet-like display member from downside so that the members are partially deformed in a protruding manner,
wherein when one of the operation instruction patterns is displayed on the sheet-like display member, the partial pressing member presses a corresponding operation area of the operation instruction pattern displayed on the sheet-like display member, and areas of the sheet-like detection member and the sheet-like display member corresponding to the operation area are deformed in a protruding manner, thereby allowing the sheet-like detection member to detect the contact position of the operation means with the operation area.

8. The electronic device according to claim 7, wherein the operation instruction pattern includes a keyboard input display pattern that has a plurality of key input operation areas and a coordinate input region display pattern that indicates a constant coordinate input region.

9. The electronic device according to claim 7, wherein the sheet-like display member includes a display layer and upper and lower electrodes disposed respectively in the upper and lower layers of the display layer, and the upper electrode has a shape corresponding to the various operation instruction patterns.

10. The electronic device according to claim 9, wherein the display layer is formed of an organic electroluminescence layer.

11. The electronic device according to claim 7, wherein the sheet-like detection member detects the contact position of the operation means on the basis of a variation in electrostatic capacity between electrodes.

12. The electronic device according to claim 7, wherein the partial pressing member allows a plurality of small protrusions to press the same operation area.
